(19) United States
(12) Patent Application Publication
(10) Pub. No.: US 2025/0253590 A1
(43) Pub. Date: Aug. 7, 2025

(54) SHIELD CONNECTOR

(71) Applicant: YAZAKI CORPORATION, Tokyo (JP)

(72) Inventors: Noboru Hayasaka, Makinohara-shi (JP); Kenshiro Shigemoto, Makinohara-shi (JP); Shinya Tachibana, Makinohara-shi (JP)

(21) Appl. No.: 19/041,977

(22) Filed: Jan. 30, 2025

(30) Foreign Application Priority Data
Feb. 5, 2024 (JP) 2024-015331

(51) Int. Cl. H01R 13/6581

(52) U.S. Cl. CPC H01R 13/6581

(57) ABSTRACT

A shield connector includes: a wiring member including a conductor and a sheath covering the conductor; a cylindrical shield member configured to allow the wiring member to be inserted thereinto; a housing configured to hold an end portion of the wiring member; and a shield shell having a fixing portion fixed to a wall portion of a device and a pressing portion, the shield shell covering the housing, in which the shield shell is configured to sandwich the shield member between the pressing portion and the wall portion in a state in which the fixing portion is fixed to the wall portion.

### CROSS-REFERENCE TO RELATED APPLICATION(S)

The present application claims priority to and incorporates by reference the entire contents of Japanese Patent Application No. 2024-015331 filed in Japan on Feb. 5, 2024.

### BACKGROUND OF THE INVENTION

### 1. Field of the Invention

The present invention relates to a shield connector.

### 2. Description of the Related Art

In the related art, there is a shield connector. The shield connector disclosed in Japanese Patent Application Laid-open No. 2023-005221 includes a wire shield member. The wire shield member includes a lower shield shell serving as a second shield shell electrically connected to an upper shield shell, and a braid covering a wire led out from a wire insertion portion. The upper shield shell has three screw holes formed therein and configured to allow third fastening members for fastening two wire shield members to be respectively screwed thereinto.

In a shield connector, the number of components and an assembly process tend to increase, and as such, assembly work tends to be complicated. In the shield connector, it is desired to simplify assembly work.

### SUMMARY OF THE INVENTION

An object of the present invention is to provide a shield connector capable of simplifying assembly work.

In order to achieve the above mentioned object, a shield connector according to one aspect of the present invention includes a wiring member including a conductor and a sheath covering the conductor; a cylindrical shield member configured to allow the wiring member to be inserted thereinto; a housing configured to hold an end portion of the wiring member; and a shield shell having a fixing portion fixed to a wall portion of a device and a pressing portion, the shield shell covering the housing, wherein the shield shell is configured to sandwich the shield member between the pressing portion and the wall portion in a state in which the fixing portion is fixed to the wall portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a shield connector according to an embodiment;

FIG. 2 is a side view of the shield connector according to the embodiment;

FIG. 3 is a plan view of the shield connector according to the embodiment;

FIG. 4 is an exploded perspective view of the shield connector according to the embodiment;

FIG. 5 is a perspective view of a housing according to the embodiment;

FIG. 6 is a perspective view of a shield shell according to the embodiment; and

FIG. 7 is a cross-sectional view of the shield connector according to the embodiment.

### DETAILED DESCRIPTION OF THE PREFERRED EMBODIMENTS

Hereinafter, a shield connector according to an embodiment of the present invention will be described in detail with reference to the drawings. It is noted that the present invention is not limited by the embodiment. In addition, configuration elements in the following embodiment include those that can be easily assumed by those skilled in the art or those that are substantially the same.

### EMBODIMENT

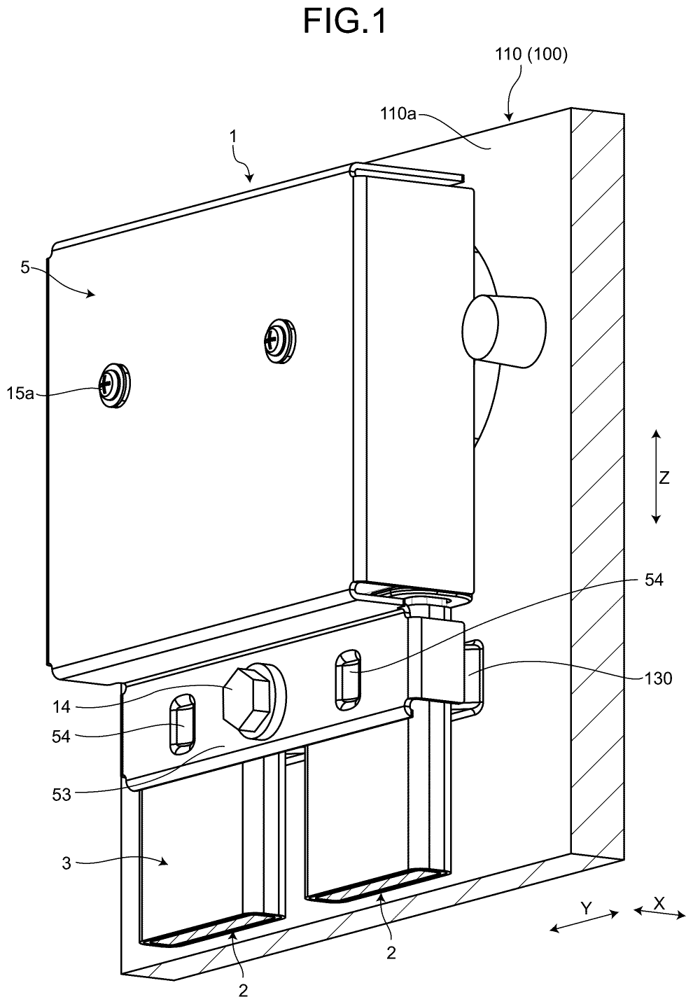

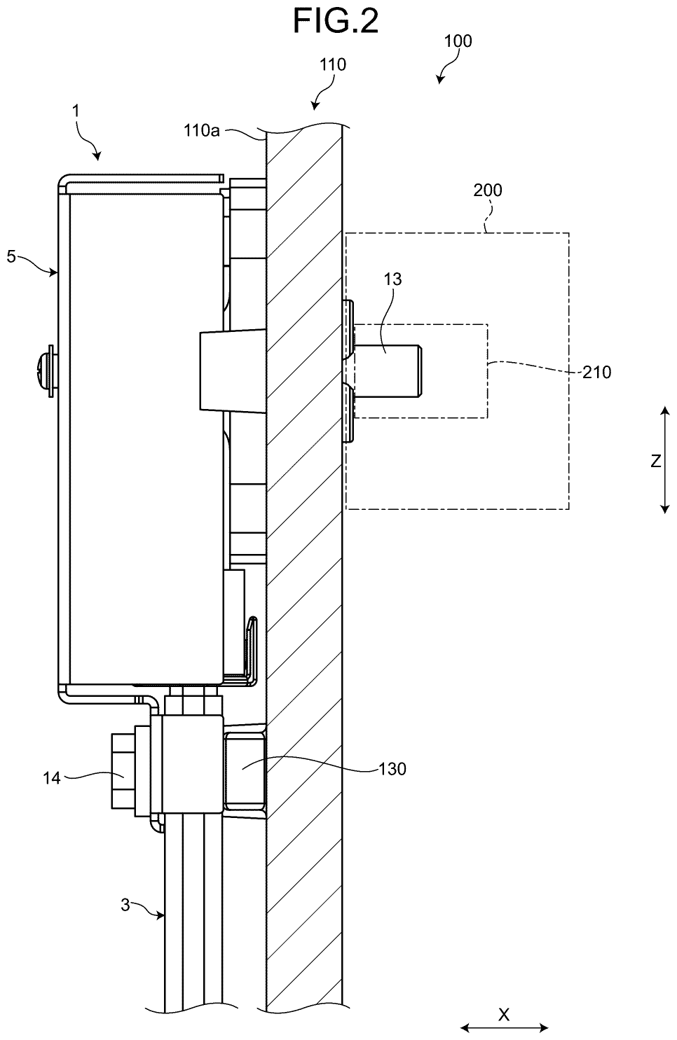

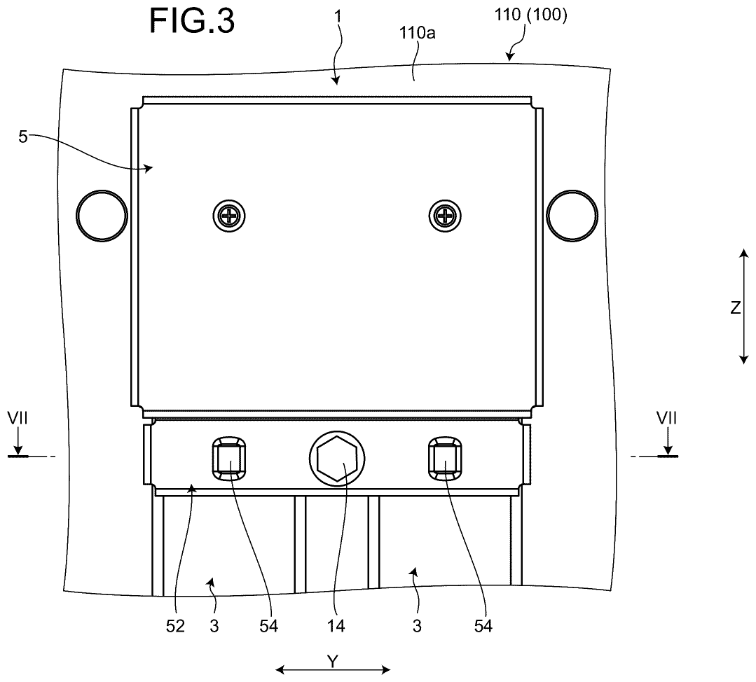

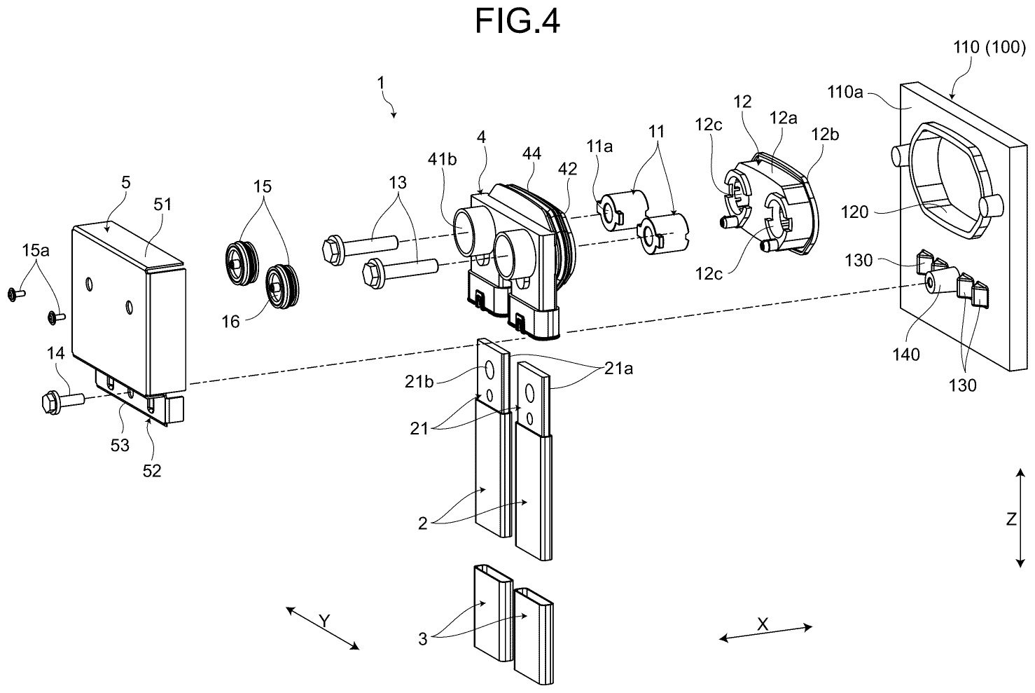

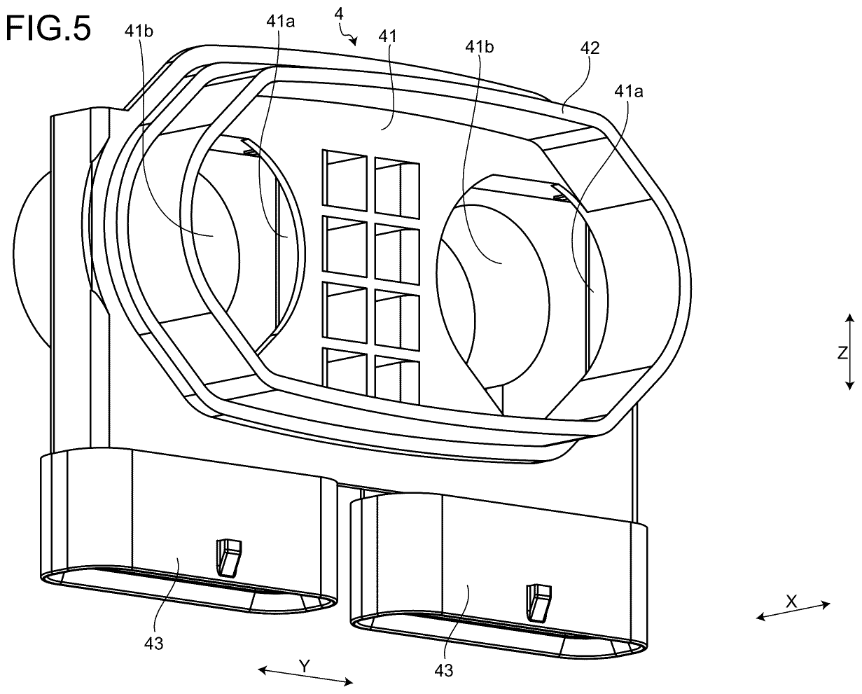

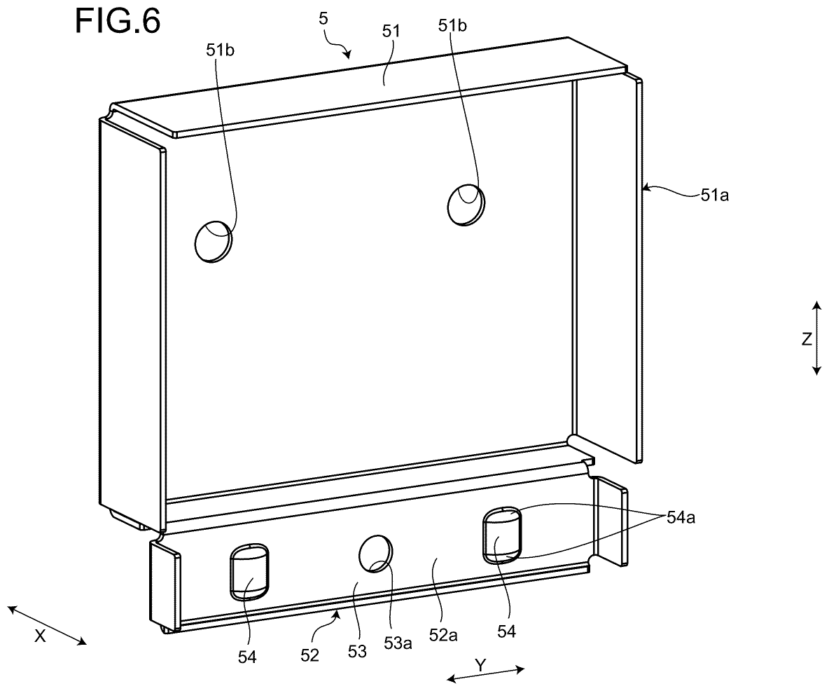

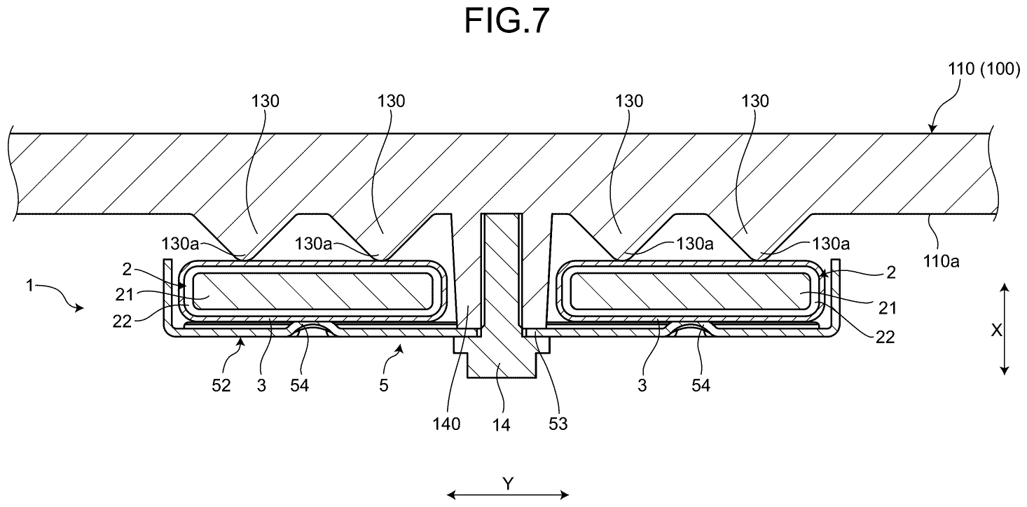

An embodiment will be described with reference to FIGS. 1 to 7. The present embodiment relates to a shield connector. FIG. 1 is a perspective view of a shield connector according to an embodiment, FIG. 2 is a side view of the shield connector according to the embodiment, FIG. 3 is a plan view of the shield connector according to the embodiment, FIG. 4 is an exploded perspective view of the shield connector according to the embodiment, FIG. 5 is a perspective view of a housing according to the embodiment, FIG. 6 is a perspective view of a shield shell according to the embodiment, and FIG. 7 is a cross-sectional view of the shield connector according to the embodiment. FIG. 7 illustrates a cross section taken along line VII-VII of FIG. 3.

As illustrated in FIGS. 1 and 4, a shield connector 1 includes a wiring member 2, a shield member 3, a housing 4, a shield shell 5, a collar 11, a front holder 12, a bolt 13, a fixing member 14, and a packing 15. The shield connector 1 is fixed to a wall portion 110 of a device 100. The wall portion 110 is, for example, a wall portion constituting a housing of the device. The wall portion 110 has conductivity and is made of, for example, metal.

As illustrated in FIG. 2, the shield connector 1 is connected to an apparatus 200. The apparatus 200 is disposed inside the device 100 and is fixed to, for example, the wall portion 110. The apparatus 200 may be a connector, a terminal block, or other types of apparatus. The apparatus 200 has a conductor 210. The wiring member 2 of the shield connector 1 is electrically connected to the conductor 210.

As illustrated in FIG. 4, a through hole 120 is provided in the wall portion 110 of the device 100. The through hole 120 is opened in an outer wall surface 110a of the wall portion 110 and penetrates the wall portion 110. That is, the through hole 120 allows an external space and an internal space of the housing of the device 100 to communicate with each other.

The housing 4 of the shield connector 1 has a fitting portion 42 that fits into the through hole 120. The fitting portion 42 is inserted into the through hole 120 in the axial direction of the through hole 120. In the present specification, a direction in which the fitting portion 42 of the housing 4 is inserted into the through hole 120 is referred to as a first direction X. The width direction of the housing 4 is referred to as a second direction Y, and the height direction of the housing 4 is referred to as a third direction Z. The housing 4 holds the plurality of wiring members 2 arranged in the second direction Y. The wiring member 2 is inserted into the housing 4 in the third direction Z. The second direction Y is orthogonal to the first direction X, and the third direction Z is orthogonal to both the first direction X and the second direction Y.

A plurality of protrusions 130 and a support portion 140 are disposed on the wall portion 110. The protrusion 130 comes into contact with the shield member 3 of the shield connector 1 to support the shield member 3. Each of the protrusions 130 protrudes from the wall surface 110a in the first direction X. The plurality of protrusions 130 are arranged side by side in the second direction Y. The wall portion 110 of the present embodiment has four protrusions 130. The two protrusions 130 support one shield member 3, and the other two protrusions 130 support the other shield member 3. The shape of each of the protrusions 130 is a tapered shape having a width that decreases toward a tip of the protruding direction. The illustrated protrusion 130 has a substantially triangular prism shape extending in the third direction Z. The width of the protrusion 130 in the second direction Y becomes narrower in a direction away from the wall surface 110a.

The support portion 140 supports an opposing wall 52 of the shield shell 5. The support portion 140 protrudes from the wall surface 110a in the first direction X. The shape of the support portion 140 is a cylindrical shape or a truncated cone shape. The support portion 140 has a screw hole formed therein and configured to correspond to the fixing member 14. The screw hole of the support portion 140 extends in the first direction X. Each of the opposite sides of the support portion 140 has two protrusions 130 disposed in the second direction Y. In other words, the support portion 140 is disposed between the two protrusions 130 and the other two protrusions 130.

The wiring member 2 of the present embodiment is a bus bar coated with an insulating coating. The wiring member 2 includes a conductor 21 and a sheath 22. The conductor 21 is a plate-like member made of conductive metal. The illustrated conductor 21 has a flat plate shape. The sheath 22 is an insulating layer formed on the surface of the conductor 21. The sheath 22 is, for example, an insulating synthetic resin. A connecting portion 21a exposed from the sheath 22 is provided at an end portion of the conductor 21. The connecting portion 21a has a through hole 21b formed therein and configured to correspond to the bolt 13.

The shield member 3 is a cylindrical member configured to allow the wiring member 2 to be inserted thereinto, and has conductivity. The shield member 3 is, for example, a pipe formed of a conductive metal. The cross-sectional shape of the shield member 3 corresponds to the shape of the wiring member 2. The cross-sectional shape of the shield member 3 is, for example, substantially rectangular. The wiring member 2 is inserted into the shield member 3 such that a portion having the sheath 22 is housed in the shield member 3.

As illustrated in FIG. 5, the housing 4 includes a holding portion 41, the fitting portion 42, and two cylindrical portions 43. The holding portion 41 is a main body portion that holds the connecting portion 21a of the wiring member 2. The holding portion 41 has two recessed portions 41a configured to allow the connecting portions 21a of the conductors 21 to be respectively inserted thereinto. The recessed portion 41a extends in the third direction Z inside the holding portion 41. Two through holes 41b extending in the first direction X are formed in the holding portion 41. Each of the through holes 41b is open to a wall surface surrounding the recessed portion 41a. When the wiring member 2 is inserted into the recessed portion 41a, the through hole 21b of the wiring member 2 faces the through hole 41b.

The fitting portion 42 protrudes from the holding portion 41 in the first direction X. The fitting portion 42 is formed in a cylindrical shape having an axis in the first direction X. The cross-sectional shape of the fitting portion 42 corresponds to the shape of the through hole 120. The cross-sectional shape of the illustrated fitting portion 42 is a substantially oval shape. The two through holes 41b are open toward the internal space of the fitting portion 42.

The cylindrical portion 43 protrudes from the holding portion 41 in the third direction Z. The cylindrical portion 43 is formed in a cylindrical shape having an axis in the third direction Z. The two cylindrical portions 43 are arranged in the second direction Y. The cross-sectional shape of the cylindrical portion 43 corresponds to the shape of the wiring member 2. The cross-sectional shape of the illustrated cylindrical portion 43 is substantially rectangular. The internal space of the cylindrical portion 43 is connected to the recessed portion 41a. The connecting portion 21a of the wiring member 2 is inserted into the recessed portion 41a through the cylindrical portion 43 in the third direction Z.

As illustrated in FIG. 4, an annular packing 44 is attached to the outer surface of the fitting portion 42. The packing 44 seals a space defined between the fitting portion 42 and the through hole 120. The front holder 12 is attached to the fitting portion 42 in the first direction X. The front holder 12 includes an insertion portion 12a to be inserted into the fitting portion 42 and a flange portion 12b. The insertion portion 12a has two through holes 12c provided therein. The through hole 12c is disposed so as to face the through hole 41b of the housing 4. The flange portion 12b protrudes outwards from the insertion portion 12a. The flange portion 12b faces the packing 44 in the first direction X and protects the packing 44.

The collar 11 is a cylindrical member having conductivity, and is made of, for example, metal. The collar 11 has a through hole 11a formed therein and configured to allow the bolt 13 to be inserted thereinto. The shield connector 1 of the present embodiment has two collars 11 respectively corresponding to two wiring members 2. The two collars 11 are respectively inserted into the through holes 12c formed in the front holder 12 and held by the front holder 12. The through hole 11a of the collar 11 faces the through hole 21b of the wiring member 2 inserted into the housing 4.

The bolt 13 fixes the conductor 21 and the collar 11 to the conductor 210 of the apparatus 200. The bolt 13 is inserted into the through hole 41b of the housing 4. The bolt 13 is inserted into the through hole 21b of the wiring member 2 inside the housing 4, and is further inserted into the through hole 11a of the collar 11. The tip portion of the bolt 13 is screwed into a screw hole formed in the apparatus 200. The conductor 210 may have a screw hole formed therein and configured to correspond to the bolt 13. In this case, the conductor 21 may be electrically connected to the conductor 21 with the collar 11 interposed therebetween.

The packing 15 is inserted into the through hole 41b of the housing 4 to close the through hole 41b. The packing 15 has an annular shape and is inserted into the through hole 41b in a state of being attached to a shaft member 16.

The shield shell 5 is a cover member having conductivity, and is formed of, for example, a metal plate. The shield shell 5 includes a shell main body 51 and the opposing wall 52. The shell main body 51 houses the housing 4 therein. As illustrated in FIG. 6, the shape of the shell main body 51 is a substantially rectangular parallelepiped and has an opening 51a. The housing 4 is inserted into the shell main body 51 from the opening 51a. The shell main body 51 has two through holes 51b provided therein. As illustrated in FIG. 4, the screw members 15a are respectively inserted into the through holes 51b. The screw members 15a are respectively screwed to the shaft members 16 each holding the packing 15.

The opposing wall 52 is a plate-like portion facing the wall surface 110a of the device 100. As illustrated in FIG. 6, the opposing wall 52 is connected to an end portion of the shell main body 51 in the third direction Z and extends in the second direction Y. The opposing wall 52 has an opposing surface 52a facing the wall surface 110a. The opposing surface 52a faces the wall surface 110a in the first direction X. The opposing surface 52a is a flat surface. The opposing wall 52 includes a fixing portion 53 and a pressing portion 54.

The fixing portion 53 is a portion fixed to the wall surface 110a. The fixing portion 53 is located at a central portion of the opposing wall 52 in the second direction Y. The fixing portion 53 has one through hole 53a provided therein. As illustrated in FIG. 2 and the like, the fixing portion 53 is fixed to the wall portion 110 by the fixing member 14. The fixing member 14 of the present embodiment is a bolt. The fixing member 14 is inserted into the through hole 53a and is screwed into the support portion 140 of the device 100. The shield connector 1 is fixed to the wall portion 110 by the fixing member 14 in a state in which the fitting portion 42 of the housing 4 is fitted into the through hole 120.

As illustrated in FIG. 6, the shield shell 5 of the present embodiment has two pressing portions 54. The two pressing portions 54 are disposed opposite to each other in the second direction Y with the fixing portions 53 interposed therebetween. The through hole 53a is disposed at a central portion between the two pressing portions 54. One pressing portion 54 corresponds to one wiring member 2, and the other pressing portion 54 corresponds to the other wiring member 2.

The pressing portion 54 of the present embodiment is formed by deforming a part of the opposing wall 52. The pressing portion 54 protrudes in the first direction X. That is, the pressing portion 54 is formed as a protrusion protruding from the opposing surface 52a. The shape of the illustrated pressing portion 54 is a substantially cylindrical shape. That is, the cross-sectional shape of the pressing portion 54 in the cross section orthogonal to the third direction Z is a circular arc shape. Spherical chamfered portions 54a are respectively provided at opposite end portions of the pressing portion 54 in the third direction Z.

FIG. 7 illustrates a cross section of the shield connector 1 fixed to the wall portion 110. As illustrated in FIG. 7, the fixing portion 53 of the shield shell 5 is fixed to the support portion 140 by the fixing member 14. The shield shell 5 sandwiches the shield member 3 between the pressing portion 54 and the wall portion 110 in a state in which the fixing portion 53 is fixed to the wall portion 110. The shield member 3 is sandwiched between the pressing portion 54 and the protrusion 130 of the wall portion 110, and is electrically connected to each of the pressing portion 54 and the protrusion 130. Therefore, the shield shell 5 is grounded to the wall portion 110 with the shield member 3 interposed therebetween. It is noted that the shield shell 5 may be grounded to the support portion 140.

According to the shield connector 1 of the present embodiment, the shield member 3 is pressed toward the wall portion 110 by the shield shell 5. Therefore, improvement in shielding performance and improvement in heat dissipation are realized. In addition, the shield connector 1 is fixed to the wall portion 110 and the shield shell 5 and the shield member 3 are grounded to the wall portion 110 by a process of screwing the fixing member 14 to the support portion 140. Therefore, the number of steps in the work of assembling the shield connector 1 with the device 100 can be reduced, and workability is improved.

As illustrated in FIG. 7, the pressing portion 54 is disposed between the two protrusions 130 in the second direction Y. Therefore, the pressing portion 54 can stabilize shielding performance of a shield circuit by bringing the shield member 3 into contact with the two protrusions 130. The fixing portion 53 of the shield shell 5 is disposed between the two pressing portions 54. Therefore, fastening force by the fixing member 14 is transmitted from the two pressing portions 54 to the shield member 3. Therefore, the bias of force of pressing the two shield members 3 against the wall portion 110 hardly occurs. As a result, variation hardly occurs between shielding performance for one wiring member 2 and shielding performance for the other wiring member 2.

As described above, the shield connector 1 of the present embodiment includes the wiring member 2, the shield member 3, the housing 4, and the shield shell 5. The wiring member 2 includes the conductor 21 and the sheath 22 covering the conductor 21. The shield member 3 is a cylindrical member configured to allow the wiring member 2 to be inserted thereinto. The housing 4 holds an end portion of the wiring member 2. The shield shell 5 is a member that covers the housing 4, and includes the fixing portion 53 and the pressing portion 54. The fixing portion 53 is fixed to the wall portion 110 of the device 100.

The shield shell 5 is configured to sandwich the shield member 3 between the pressing portion 54 and the wall portion 110 in a state in which the fixing portion 53 is fixed to the wall portion 110. According to the shield connector 1 of the present embodiment, the number of steps in the work of assembling the shield connector 1 with the device 100 can be reduced, and workability is improved. In addition, the shield connector 1 of the present embodiment can press and hold the cylindrical shield member 3 toward the wall portion 110. Therefore, the shield connector 1 of the present embodiment can improve shielding performance. In addition, the shield connector 1 of the present embodiment can dissipate heat generated by the wiring member 2 and the like from the shield member 3 to the wall portion 110 and improve heat dissipation of the shield connector 1.

The shield shell 5 of the present embodiment has the opposing surface 52a facing the wall portion 110. The pressing portion 54 is a protrusion protruding from the opposing surface 52a. The pressing portion 54 configured as a protrusion can form a stable contact point between the shield member 3 and the shield shell 5.

The conductor 21 is, for example, a bus bar. The sheath 22 is, for example, an insulating layer coated on the conductor 21. The shield member 3 may be a metal pipe having rigidity. Such a shield member 3 can have appropriate rigidity against pressing force received from the pressing portion 54. The shield member 3 which is a metal pipe can appropriately protect the inserted wiring member 2.

It is noted that the number of the wiring members 2 connected to the shield connector 1 is not limited to the two illustrated examples. The conductor 21 of the wiring member 2 is not limited to a bus bar. The conductor 21 may be, for example, an electric wire.

The contents disclosed in the above embodiments can be appropriately combined with each other and executed.

In the shield connector according to the present embodiment, a shield shell includes a fixing portion fixed to a wall portion of a device and a pressing portion. The shield shell is configured to sandwich a shield member between the pressing portion and the wall portion in a state in which the fixing portion is fixed to the wall portion. According to the shield connector of the present embodiment, the fixing portion of the shield shell is fixed to the wall portion, so that the shield member can be grounded to the wall portion. Therefore, the shield connector according to the present embodiment has an effect of being capable of simplifying assembly work.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A shield connector comprising:
a wiring member including a conductor and a sheath covering the conductor;
a cylindrical shield member configured to allow the wiring member to be inserted thereinto;
a housing configured to hold an end portion of the wiring member; and
a shield shell having a fixing portion fixed to a wall portion of a device and a pressing portion, the shield shell covering the housing,
wherein the shield shell is configured to sandwich the shield member between the pressing portion and the wall portion in a state in which the fixing portion is fixed to the wall portion.

2. The shield connector according to claim 1, wherein
the shield shell has an opposing surface facing the wall portion, and
the pressing portion is a protrusion protruding from the opposing surface.

3. The shield connector according to claim 1, wherein
the conductor is a bus bar,
the sheath is an insulating layer coated on the conductor, and
the shield member is a metal pipe having rigidity.
